(19) United States
(12) Patent Application Publication
(10) Pub. No.: US 2023/0067028 A1
(43) Pub. Date: Mar. 2, 2023

(54) Safety Stair Device

(71) Applicant: Johnnie Williams, Edmond, OK (US)

(72) Inventor: Johnnie Williams, Edmond, OK (US)

(21) Appl. No.: 17/847,420

(22) Filed: Jun. 23, 2022

Related U.S. Application Data
(60) Provisional application No. 63/240,088, filed on Sep. 2, 2021.

(51) Int. Cl. E06C 7/16; E06C 7/18

(52) U.S. Cl. CPC E06C 7/16; E06C 7/181

(57) ABSTRACT

The present invention relates to a novel safety stair device that is designed to safely and easily allow a user to enter and exit a storm shelter. The device comprises a set of stairs that are secured against the rungs of the storm shelter ladder. The set of stairs comprise indentations at the back of the stairs, such that the set of stairs can be slid over the existing ladder rungs via the indentations, securing the set of stairs in place. The set of stairs are also padded to allow users to slide down the stairs without developing abrasions, scrapes, etc. Thus, users with low mobility can safely utilize the device to enter and exit a storm shelter.

### CROSS-REFERENCE TO RELATED APPLICATION

The present application claims priority to, and the benefit of, U.S. Provisional Application No. 63/240,088, which was filed on Sep. 2, 2021 and is incorporated herein by reference in its entirety.

### FIELD OF THE INVENTION

The present invention relates generally to the field of safety stair devices. More specifically, the present invention relates to an improved safety stair device that comprises a set of stairs that are padded. The device is inserted into the preexisting brackets and rungs of a storm shelter ladder. The safety stair device allows users with disabilities to easily walk or slide down the stairs into the storm shelter. Accordingly, the present disclosure makes specific reference thereto. Nonetheless, it is to be appreciated that aspects of the present invention are also equally applicable to other like applications, devices and methods of manufacture.

### BACKGROUND

By way of background, the use of a shelter to protect users from dangerous forces, such as tornadoes, hurricanes and/or bombs is not new. Typically, these shelters utilize a ladder, or set of rungs or steps, which users use to enter and exit the shelter. The ladder in the shelter is generally manufactured of wood, and the rungs or steps are hard and uncomfortable. Specifically, the ladder can cause pressure on specific areas of the body, especially those susceptible to sores. Thus, utilizing the wooden ladder in a storm shelter can be dangerous and uncomfortable.

Furthermore, users with disabilities and/or balance issues may find that ladders in storm shelters are unstable and awkward to use. However, if a disabled user or a user with balance issues attempted to slide down the ladder to enter the storm shelter instead of walking down the ladder, the friction from sliding on the wooden surface would cause blisters and/or skin tears, among other possible injuries. Accordingly, disabled users and/or users with balance issues would have a difficult time safely using the ladder in a storm shelter.

Thus, it is necessary for users of all abilities to be able to safely enter and exit a storm shelter when needed. Generally, during inclement weather times, it is necessary for users to enter and exit a storm shelter for safety. However, users with disabilities or mobility issues are unable to safely enter a storm shelter using the wooden ladder typically provided for such shelters. Therefore, users of all abilities require a device that safely allows them to enter and exit a storm shelter as needed.

Therefore, there exists a long-felt need in the art for a safety stair device that allows users of all abilities to enter and exit a storm shelter. There is also a long-felt need in the art for a safety stair device that eliminates the need for users to refrain from entering or exiting a storm shelter. Further, there is a long-felt need in the art for a safety stair device that simplifies the process of entering a storm shelter, by allowing users to slide down the stair device without injury. Moreover, there is a long-felt need in the art for a device that provides a safe means for users with mobility issues to easily enter and exit a storm shelter. Further, there is a long-felt need in the art for a safety stair device that can be used for allowing users of all abilities the means to enter and exit a storm shelter. Finally, there is a long-felt need in the art for a safety stair device that offers a way for users with any mobility issues to easily and safely enter and exit a storm shelter.

The subject matter disclosed and claimed herein, in one embodiment thereof, comprises a safety stair device. The device is designed to safely and easily allow a user to enter and exit a storm shelter. The device comprises a set of stairs that are secured against the rungs of the storm shelter ladder. The set of stairs comprise indentations at the back of the stairs, such that the set of stairs can be slid over the existing ladder rungs via the indentations, securing the set of stairs in place. The set of stairs are also padded to allow users to slide down the stairs without developing abrasions, scrapes, etc. Further, the set of stairs is wider than the storm shelter ladder, to allow users more stability during use.

In this manner, the safety stair device of the present invention accomplishes all of the forgoing objectives and provides users with a device that safely and easily allows users to enter and exit a storm shelter. The device provides a simplified process for users of all abilities to enter and exit a storm shelter safely. The device eliminates the need for users to refrain from entering or exiting a storm shelter during inclement weather.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a safety stair device. The device is designed to safely and easily allow a user to enter and exit a storm shelter. The device comprises a set of stairs that are secured against the rungs of the storm shelter ladder. The set of stairs comprise indentations at the back of the stairs, such that the set of stairs can be slid over the existing ladder rungs via the indentations, securing the set of stairs in place.

As used herein, the term “staircase” means the structure containing stairs; and “stairs” means a series of steps in a unitary structure. The present invention is particularly adapted for, and the illustrations are related to, a set of steps forming straight stairs down a storm shelter. However, it may be utilized in other like applications as is known in the art.

Generally, staircases utilize stringers (elongated side members) to which brackets (carriers) are secured. One type of bracket uses a continuous ribbon for each stringer, which is bent at right angles to form the supports for the stairs. The stairs are separately fabricated, with each stair comprising a pan (horizontal portion) and a riser (vertical portion). The complete stairway is assembled on-site or off-site, with the stair pan being individually secured onto the stringer brackets. The assembly is performed by clamping the stringers and pans together, to correctly align them before they are secured together.

Typically, the brackets have pre-formed holes to receive bolts, or other securing means. During assembly, the stringers are held in upright position and the floor pans are placed in their positions one after the other, resting on the brackets and bolted down. Then, the staircase is built up from the bottom stair to the top stair. Each stair pan is aligned, with its holes matching the holes of the bracket and the prior stair pan, using a guidance pin. In addition to the bolts at the sides, joining the stair pans with the brackets, additional bolts are required to join each stair pan with the riser of its adjoining stair pan. If the staircase is misaligned, multiple bolts must be loosened, the staircase re-adjusted and the bolts re-tightened. The force of the bolts, when they are being tightened, is generally sufficient to straighten the stringers and otherwise correctly align (square-up) the staircase for use. Other methods of constructing a staircase can be utilized in the present invention, such as welding, screwing, etc., as is known in the art, as long as the resultant component is a usable staircase.

Furthermore, the device comprises a set of stairs that are secured against the rungs of the storm shelter ladder. The set of stairs comprise a plurality of indentations or slots of rectangular shape positioned at the back of the stairs. The plurality of indentations align with the plurality of rungs of the storm shelter ladder. The plurality of rungs are then inserted into the plurality of indentations, such that the set of stairs can be slid over the existing ladder rungs, securing the set of stairs in place.

In yet another embodiment, the set of stairs are also padded to allow users to slide down the stairs without developing abrasions, scrapes, etc. The set of stairs can be completely padded or each stair can comprise a padded component.

The padded component is typically a foam strip having a sufficient density to provide a desirable degree of protection and including therewith a contiguous attachment means for providing a mechanical bond to various portions of the set of stairs.

The padding utilized in the device is preferably comprised of a closed-cell, cross linked polyethylene, polyethylene/EVA foam. Such materials are often referred to as super dense foam materials. Illustrative forms of the attachment means may include an adhesive strip (which may include a peelable cover strip, removable prior to attachment), adhesively mounted hook and loop fastener means, mechanical fasteners, i.e., a nut and bolt, deformable rivet, such as plastic rivets designed to pressure fit within a preformed opening, etc., or any other suitable attachment means as is known in the art. The protective padding/cushioning may be attached to any suitable part of the steps to prevent injury to a user during use.

In yet another embodiment, the safety stair device is manufactured from any suitable metal, such as aluminum, stainless steel, etc., or any suitable plastic, such as polycarbonate, or fiber-reinforced plastics, etc.

In yet another embodiment, the safety stair device is wider than the storm shelter ladder. Specifically, the set of stairs are wider than the storm shelter ladder, to allow users more stability during use. The set of stairs can be any suitable size as is known in the art, as long as they allow a user with limited mobility more stability.

In yet another embodiment, the safety stair device comprises at least one handrail. In some embodiments, the safety stair device comprises two handrails. The handrails can be any suitable handrails as is known in the art, and can be secured on the set of stairs via a fastening means, such as screws, bolts, etc. The handrail can be manufactured from the same material as the set of stairs, or a different material.

In yet another embodiment, a method of safely entering and exiting a storm shelter is described. The method includes the steps of providing a set of stairs, wherein the set of stairs comprises a plurality of indentations positioned on a back of the set of stairs. The method also comprises positioning the set of stairs, such that the plurality of indentations line up with the plurality of rungs of the storm shelter ladder. Further, the method comprises inserting the plurality of rungs into the plurality of indentations, such that the set of stairs is slid over the existing ladder rungs, securing the set of stairs in place. Once secure, a user safely utilizes the set of stairs via walking up and down the set of stairs and/or sliding down the set of stairs.

In yet another embodiment of the present invention, a safety stair device is disclosed for safely and easily allowing a user to enter and exit a storm shelter. The device comprises a set of stairs that are secured against the rungs of the storm shelter ladder. The set of stairs comprise indentations at the back of the stairs, such that the set of stairs can be slid over the existing ladder rungs via the indentations, securing the set of stairs in place. The set of stairs are also padded to allow users to slide down the stairs without developing abrasions, scrapes, etc. Further, the set of stairs is wider than the storm shelter ladder, to allow users more stability during use. Finally, the set of stairs comprises at least one handrail to provide additional safety during use.

Numerous benefits and advantages of this invention will become apparent to those skilled in the art to which it pertains, upon reading and understanding the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one embodiment of the safety stair device of the present invention in use in accordance with the disclosed architecture;

FIG. 2 illustrates a perspective view of another embodiment of the safety stair device of the present invention secured to a storm shelter ladder in accordance with the disclosed architecture;

FIG. 3 illustrates a perspective view showing how the indentations of the safety stair device of the present invention are aligned with the plurality of rungs of the storm shelter ladder in accordance with the disclosed architecture;

FIG. 4 illustrates a perspective view showing how the rungs of the storm shelter ladder are inserted into the indentations of the safety stair device of the present invention in accordance with the disclosed architecture;

FIG. 5 illustrates a perspective view of one embodiment of the safety stair device of the present invention secured to the storm shelter ladder in accordance with the disclosed architecture; and

FIG. 6 illustrates a flowchart showing the method of safely entering and exiting a storm shelter in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for a safety stair device that allows users of all abilities to enter and exit a storm shelter. There is also a long-felt need in the art for a safety stair device that eliminates the need for users to refrain from entering or exiting a storm shelter. Further, there is a long-felt need in the art for a safety stair device that simplifies the process of entering a storm shelter, by allowing users to slide down the stair device without injury. Moreover, there is a long-felt need in the art for a device that provides a safe means for users with mobility issues to easily enter and exit a storm shelter. Further, there is a long-felt need in the art for a safety stair device that can be used for allowing users of all abilities the means to enter and exit a storm shelter. Finally, there is a long-felt need in the art for a safety stair device that offers a way for users with any mobility issues to easily and safely enter and exit a storm shelter.

The present invention, in one exemplary embodiment, is a novel safety stair device that is designed to safely and easily allow a user to enter and exit a storm shelter. The device comprises a set of stairs that are secured against the rungs of the storm shelter ladder via a set of indentations at the back of the stairs. The set of stairs are also padded to allow users to slide down the stairs without developing abrasions, scrapes, etc. The present invention also includes a method of safely entering and exiting a storm shelter. The method includes the steps of providing a safety stair device for use. The method also comprises positioning the set of stairs of the device, such that the plurality of indentations line up with the plurality of rungs of the storm shelter ladder. Further, the method comprises inserting the plurality of rungs into the plurality of indentations, such that the set of stairs is slid over the existing ladder rungs, securing the set of stairs in place. Once secure, a user safely utilizes the set of stairs via walking up and down the set of stairs and/or sliding down the set of stairs.

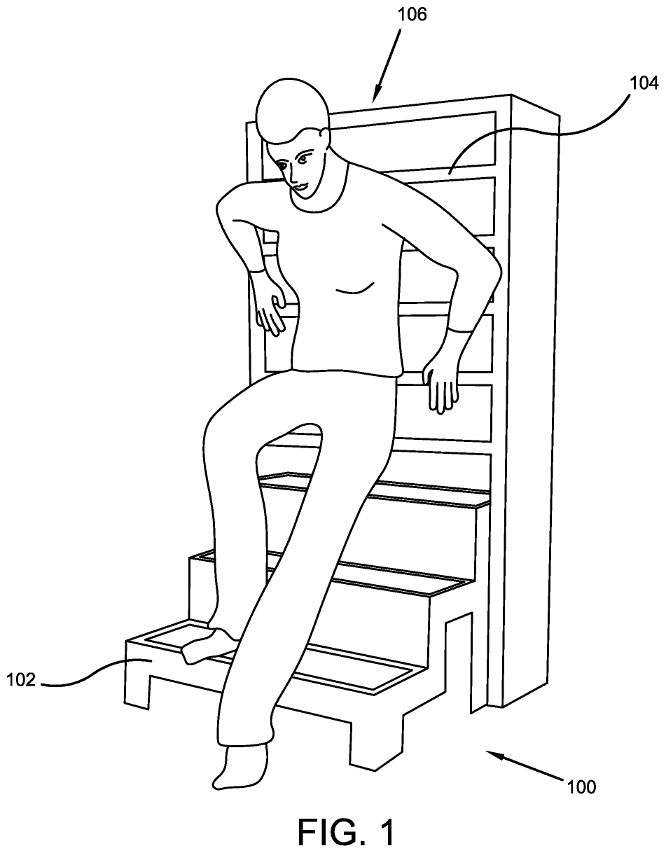

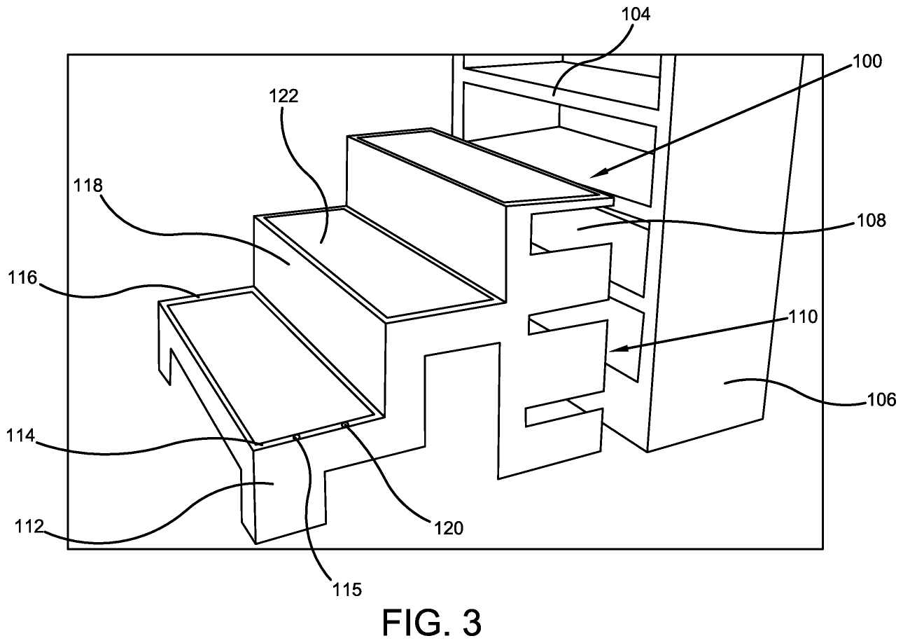

Referring initially to the drawings, FIGS. 1-3 illustrate a perspective view of one embodiment of the safety stair device 100 of the present invention. In the present embodiment, the safety stair device 100 is an improved safety stair device 100 that is designed to safely and easily allow a user to enter and exit a storm shelter. The device 100 is especially designed to allow users of varying mobility, such as users with disabilities or decreased mobility, etc., or any other suitable user as is known in the art, to easily enter and exit a storm shelter safely. More specifically, the device 100 comprises a set of stairs 102 (or staircase) that are secured against the rungs 104 of the storm shelter ladder 106. Any number of stairs 102 can be utilized as is known in the art. The set of stairs 102 comprise indentations 108 at the back 110 of the stairs 102, such that the set of stairs 102 can be slid over the existing ladder rungs 104 via the indentations 108, securing the set of stairs 102 in place.

As used herein, the term “staircase” means the structure containing stairs; and “stairs” means a series of steps in a unitary structure. The present invention is particularly adapted for, and the illustrations are related to, a set of steps forming straight stairs down a storm shelter. However, it may be utilized in other like applications as is known in the art.

Generally, staircases 102 utilize stringers 112, elongated side members, to which brackets 114 or carriers are secured. One type of bracket 114 uses a continuous ribbon for each stringer 112, which is bent at right angles to form the supports for the stairs 102. The stairs 102 are separately fabricated, with each stair 102 comprising a pan 116, horizontal portion, and a riser 118, vertical portion. The complete stairway 102 is assembled on-site or off-site, with the stair pan 116 being individually secured onto the stringer brackets 114. The assembly is performed by clamping the stringers 112 and pans 116 together, to correctly align them before they are secured together.

Typically, the brackets 114 have pre-formed holes 115 to receive bolts 120, or other securing means. During assembly, the stringers 112 are held in an upright position and the floor pans 116 are placed in their positions one after the other, resting on the brackets 114 and bolted down. Then, the staircase 102 is built up from the bottom stair to the top stair. Each stair pan 116 is aligned, with its holes 115 matching the holes of the bracket 114 and the prior stair pan 116, using a guidance pin (not shown). In addition to the bolts 120 at the sides joining the stair pans 116 with the brackets 114, additional bolts 120 are required to join each stair pan 116 with the riser 118 of its adjoining stair pan 116. If the staircase 102 is misaligned, multiple bolts 120 must be loosened, the staircase 102 re-adjusted and the bolts 120 re-tightened. The force of the bolts 120, when they are being tightened, is generally sufficient to straighten the stringers 112 and otherwise correctly align or square-up the staircase 102 for use. Other suitable methods of constructing a staircase 102 can be utilized in the present invention, such as welding, screwing, etc., as is known in the art, as long as the resultant component is a usable staircase 102.

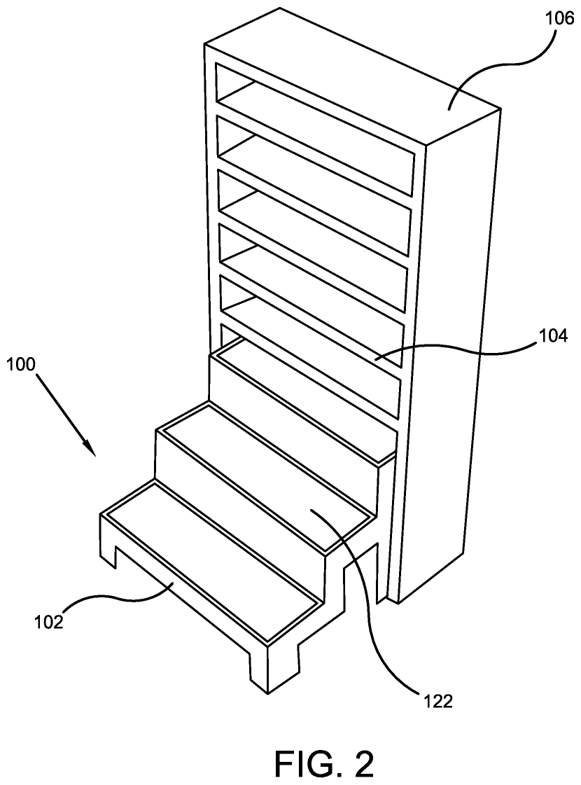

In another embodiment, the safety stair device 100 comprises a set of stairs 102 that are padded, to allow users to slide down the stairs without developing abrasions, scrapes, etc. The set of stairs 102 can be completely padded or each stair can comprise a padded component 122. The padded component 122 is typically a foam strip having a sufficient density to provide a desirable degree of protection and including therewith a contiguous attachment means 202 (see FIG. 2) for providing a mechanical bond to various portions of the set of stairs.

The padding utilized in the device 100 is preferably comprised of a closed-cell, cross linked polyethylene, polyethylene/EVA foam. Such materials are often referred to as super dense foam materials. Further, illustrative forms of the attachment means 202 may include an adhesive strip, which may include a peelable cover strip, which is removable prior to attachment, an adhesively mounted hook and loop fastener means, a mechanical fastener, (i.e., a nut and bolt, deformable rivet, such as plastic rivets designed to pressure fit within a preformed opening, etc.), or any other suitable attachment means as is known in the art. The protective padding/cushioning 122 may be attached to any suitable part of the steps 102 to prevent injury to a user during use.

Furthermore, if a padded component 122 is utilized, the padded component 122 is approximately 1.25″×1″×10″ and is formed from a super dense polyfoam material having an outer side and an inner side. Although the padded component 122 may be sized to cover any suitable portion of the steps 102 as is known in the art, it is contemplated that in a preferred embodiment the padded component 122 will be sized from about 0.5″×10″×0.75″ to about 1″×10″×1.25″. Juxtaposed to the inner side is an adhesive material with a peel off outer layer. The outer layer can be peeled off to expose the inner adhesive layer. The padded component 122 can then be attached to the surface of the steps 102 by pressing the inner adhesive layer to the steps 102 surface. As shown in FIG. 1, the padded component 122 of elongated suitably dense polyfoam material with an outer side 124 is suitably adhered to the external face 126 of a suitably sized rigid step 102.

In another embodiment, the safety stair device 100 is manufactured from any suitable metal, such as aluminum, stainless steel, etc., or any suitable plastic, such as polycarbonate, or fiber-reinforced plastics, etc., or any other suitable material as is known in the art.

In use, the safety stair device 100 of the present invention is secured to a storm shelter ladder 106. Specifically, the device 100 comprises a set of stairs 102 that are secured against the rungs 104 of the storm shelter ladder 106. The set of stairs 102 comprise a plurality of indentations 108, or slots of rectangular shape, or any other suitable shape as is known in the art. The plurality of indentations 108 are positioned at the back 110 of the stairs 102. The plurality of indentations 108 align with the plurality of rungs 104 of the storm shelter ladder 106. The plurality of rungs 104 are then inserted into the plurality of indentations 108, such that the set of stairs 102 can be slid over the existing ladder rungs 104, securing the set of stairs 102 in place.

In another embodiment, the safety stair device 100 is wider than the storm shelter ladder 106. Specifically, the set of stairs 102 are wider than the storm shelter ladder 106, to allow users more stability during use. The set of stairs 102 can be any suitable size as is known in the art, as long as they allow a user with limited mobility more stability.

In another embodiment, the safety stair device 100 comprises at least one handrail 200. In some embodiments, the safety stair device 100 comprises two handrails 200. The handrails 200 can be any conventional handrail 200 as is known in the art, and can be secured on the set of stairs 102 via a fastening means, such as screws, bolts, etc. The handrail 200 can be manufactured from the same material as the set of stairs 102, or a different material.

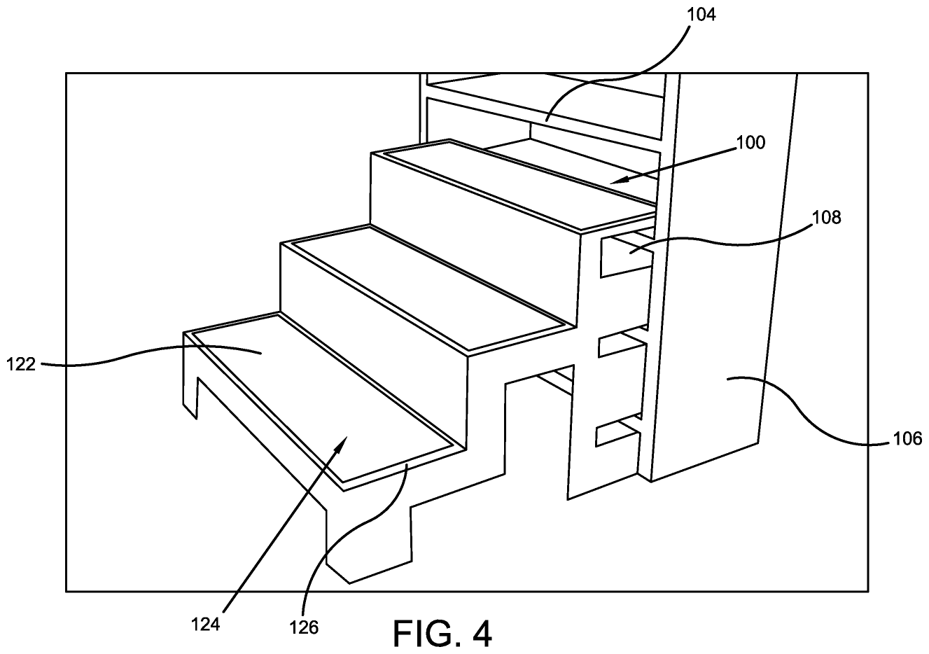

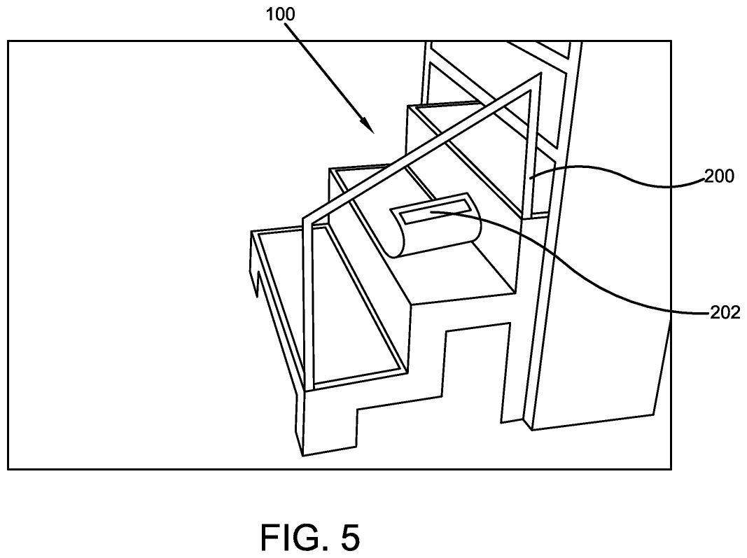

FIGS. 4-5 illustrate a perspective view of the safety stair device 100 of the present invention, showing how the indentations 108 of the safety stair device 100 are aligned with the plurality of rungs 104 of the storm shelter ladder 106. The device 100 comprises a set of stairs 102 that are secured against the rungs 104 of the storm shelter ladder 106. The set of stairs 102 comprise indentations 108 at the back 110 of the stairs 102, such that the set of stairs 102 can be slid over the existing ladder rungs 104 via the indentations 108, securing the set of stairs 102 in place. The set of stairs 102 also comprise a padded component 122, which allows users to slide down the stairs 102 without developing abrasions, scrapes, etc. Further, the set of stairs 102 is wider than the storm shelter ladder 106, to allow users more stability during use. Finally, the set of stairs 102 comprise at least one handrail 200 to provide additional safety during use.

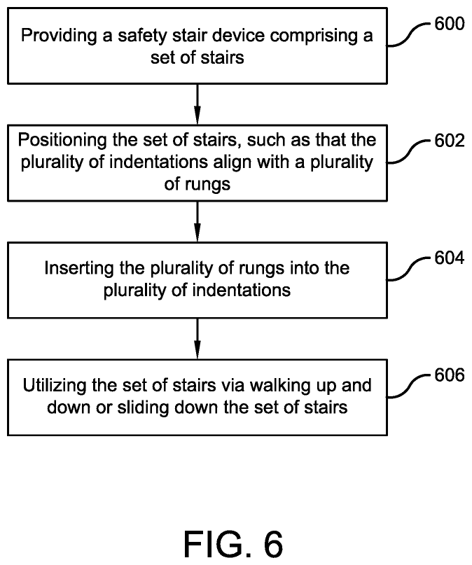

FIG. 6 illustrates a flowchart of the method of safely entering and exiting a storm shelter. The method includes the steps of at 600, providing a safety stair device comprising a set of stairs, wherein the set of stairs comprises a plurality of indentations positioned on a back of the set of stairs. The method also comprises at 602, positioning the set of stairs, such that the plurality of indentations line up with the plurality of rungs of the storm shelter ladder. Further, the method comprises at 604, inserting the plurality of rungs into the plurality of indentations, such that the set of stairs is slid over the existing ladder rungs, securing the set of stairs in place. Once secure, at 606, a user safely utilizes the set of stairs via walking up and down the set of stairs and/or sliding down the set of stairs.

Certain terms are used throughout the following description and claims to refer to particular features or components. As one skilled in the art will appreciate, different users may refer to the same feature or component by different names. This document does not intend to distinguish between components or features that differ in name but not structure or function. As used herein “safety stair device” and “device” are interchangeable and refer to the safety stair device 100 of the present invention.

Notwithstanding the forgoing, the safety stair device 100 of the present invention can be of any suitable size and configuration as is known in the art without affecting the overall concept of the invention, provided that it accomplishes the above-stated objectives. One of ordinary skill in the art will appreciate that the safety stair device 100 as shown in FIGS. 1-6 is for illustrative purposes only, and that many other sizes and shapes of the safety stair device 100 are well within the scope of the present disclosure. Although the dimensions of the safety stair device 100 are important design parameters for user convenience, the safety stair device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A safety stair device for safely and easily allowing a user to enter and exit a storm shelter comprising:
a set of stairs;
wherein the set of stairs comprise at least one padding component; and
wherein the set of stairs are secured against a plurality of rungs of a storm shelter ladder.

2. The safety stair device of claim 1, wherein the set of stairs comprise a plurality of indentations along a back of the set of stairs.

3. The safety stair device of claim 2, wherein the plurality of indentations are aligned with the plurality of rungs of the storm shelter ladder.

4. The safety stair device of claim 3, wherein the set of stairs is placed over the plurality of rungs via the plurality of indentations to secure the set of stairs in place on the storm shelter ladder.

5. The safety stair device of claim 1, wherein the set of stairs comprises a plurality of stairs.

6. The safety stair device of claim 5, wherein each of the plurality of stairs comprises a pair of stringers, to which a plurality of brackets are secured.

7. The safety stair device of claim 6, wherein each of the plurality of stairs comprises a pan and a riser.

8. The safety stair device of claim 7, wherein each pan is secured onto the pair of stringers via at least two of the plurality of brackets.

9. The safety stair device of claim 8, wherein each of the plurality of brackets comprises pre-formed openings to receive a fastener.

10. The safety stair device of claim 9, wherein the set of stairs increases in elevation from a bottom stair to a top stair.

11. The safety stair device of claim 1, wherein the at least one padded component comprises a foam strip having a sufficient density to provide a desirable degree of protection.

12. The safety stair device of claim 11, wherein the at least one padding component comprises a closed-cell, cross linked polyethylene or a polyethylene/EVA foam.

13. The safety stair device of claim 12, wherein the at least one padded component comprises an attachment means to bond to the set of stairs.

14. The safety stair device of claim 13, wherein the attachment means comprises at least one of an adhesive strip, an adhesively mounted hook and loop fastener means and a mechanical fastener.

15. The safety stair device of claim 1, wherein the set of stairs are manufactured from an aluminum, a stainless steel, a polycarbonate or a fiber-reinforced plastic.

16. The safety stair device of claim 1 further comprising at least one handrail.

17. The safety stair device of claim 1, wherein the set of stairs is wider than the storm shelter ladder.

18. A safety stair device for safely and easily allowing a user to enter and exit a storm shelter comprising:
a set of stairs comprising a plurality of stairs;
a storm shelter ladder comprising a plurality of rungs;
wherein each of the plurality of stairs comprise at least one padding component with an attachment means to bond to the plurality of stairs;
wherein the attachment means comprises at least one of an adhesive strip, an adhesively mounted hook and loop fastener means and a mechanical fastener;
wherein the set of stairs further comprises a plurality of indentations along a back portion of the set of stairs;
wherein the plurality of indentations are aligned with the plurality of rungs of the storm shelter ladder; and
further wherein the set of stairs is placed over the plurality of rungs via the plurality of indentations to secure the set of stairs in place on the storm shelter ladder.

19. The safety stair device of claim 18 further comprising at least one handrail.

20. The method of safely entering and exiting a storm shelter comprising the steps of:
providing a safety stair device comprising a set of stairs having a plurality of indentations positioned along a back portion of the set of stairs and at least one padding component;
positioning the set of stairs such that the plurality of indentations align with a plurality of rungs of a storm shelter ladder;
inserting the plurality of rungs into the plurality of indentations, such that the set of stairs is positioned over the plurality of rungs, thereby securing the set of stairs in place relative to the storm shelter ladder; and
utilizing the set of stairs via walking up and down the set of stairs or sliding down the set of stairs on the at least one padding component.
